(19) United States
(12) Patent Application Publication
(10) Pub. No.: US 2009/0115370 A1
(43) Pub. Date: May 7, 2009

(54) Power Controller for Reducing Power Consumption of Off-Line Energy Loads

(76) Inventors: Robert Vasko, San Diego, CA (US); John Raymond Vasko, JR., San Diego, CA (US)

Correspondence Address: GORDON & REES LLP, 101 WEST BROADWAY, SUITE 1600, SAN DIEGO, CA, 92101, US

(21) Appl. No.: 11/935,895

(22) Filed: Nov. 6, 2007

(51) Int. Cl. H02J 7/00

(52) U.S. Cl. 320/115; 320/107; 320/114

(57) ABSTRACT

An AC powered charging station for multiple charger adapters is provided. The charging station includes a housing with at least one stowage volume with at least three sides collectively sized to accommodate multiple charger adapters. At least one AC outlet is accessible from said stowage volume. At least one relay is connected to at least one relay controlled AC outlet accessible from the storage volume. At least one timer is connected to at least one relay controlled AC outlet, and a timer activation switch may activate the timer to begin a power on cycle. The charging station may also include a storage area for storing devices. The storage are may include a plurality of leads for leading DC connectors from the stowage volume to the storage area.

### FIELD OF THE INVENTION

The present invention relates generally to power controllers, and more particularly to power controllers that selectively connect and disconnect the power supplied to connected devices.

### BACKGROUND OF THE INVENTION

Many electronic devices consume power when they are switched off or when their task is complete. Chief among these are external power adapters. External Power adapters typically are boxy transformers that plug directly into an electrical outlet and then have a long DC cord to connect via a proprietary DC connector to the portable device. Other adapters supply power via an AC power cord to a transformer and rectifier case and then via a low voltage cord and proprietary connector to provide DC charging voltage to a portable, battery-powered device. Both types are referred to herein as external power adapters or charger adapters. It has been estimated by the Energy Star program of the U.S. Environmental Protection Agency that these devices consume 15 billion kilowatts of electricity every year. There are presently an average of 5 to 10 of these power adapters in every U.S. home. One billion new power adapters are shipped every year.

Many other electronic devices consume power when they are not in use. For example, computer printers draw power, even though they are not printing and even when the associated computer is turned off. Televisions draw substantial power when they are off, so that the picture can be displayed quickly when they are switched on.

For the purposes of this application the condition in appliances that cause them to draw power when they are switched off is referred to as readiness state power or idle state power.

This waste of power has been recognized for a long time and solutions proposed that focus primarily on making the power adapters more efficient.

### SUMMARY OF THE INVENTION

It has been discovered that a companion problem, that of the proliferation of power adapters, portable devices and their cords has a solution that resolves both the energy wastage and organizes the tangle of cords, shortage of accessible outlets and provides a central location for multiple portable devices all at the same time. The ability to power adapters at the same time provides a central collection station for portable devices which are otherwise dispersed throughout the house or office and therefore time consuming to retrieve and easy to overlook.

A further discovery is that all needs for an AC powered charger adapter station cannot be met with a single configuration. The invention includes the design of an interchangeable power module that may be fitted in multiple housing designs. The module in the exemplary embodiment is generally rectangular in front and rear aspect creating front and rear panels. The front panel incorporates the controls and indicators, with the rear panel incorporating the timer controlled outlets. The module is adapted to snap or slide into a variety of housings. For example the basic device might have a housing with a stowage area for AC adapters underneath and an open-topped storage area above. The front wall of the base is sized to accept the power module. The module is snapped or slid into position, which presents the controls at the front of the housing and presents the outlets to the stowage volume. This configuration permits the same power module to be used in a variety of other housings such as a housing that incorporates a goose neck light, or one that provides for stowage for other articles in addition to the storage of the portable devices. This might be a receptacle for pens and pencils.

In the exemplary embodiment the power module has two microprocessor controlled timers controlling a total of three outlets. A slide switch is utilized to select a timer interval. Normally this interval is selected to correspond to the approximate time that it takes for the connected portable device or devices to become fully charged. For example the user might select an interval of 4 hours to charge a cell phone, and an interval of 2 hours to charge an MP3 player or portable gaming device. Two pulse switches are provided to initiate the timer cycle. When activated the associated relay closes, AC power is provided to the connected device(s) and a LED is illuminated to confirm to power is on. After the selected charge cycle the timer opens the relay and all AC power is removed from the devices.

The invention specifically contemplates that one or more of the timer controlled outlets may be used to power a remote device such as a power strip where a large number of power adapters may be plugged in. In this way the power controller can control a large number of devices that are out of sight. These devices may be power adapter powered devices or might include plug in appliances such as a TV set. When used with plug in devices, the user determines how long the device will be required, such as selecting 4 hours for the outlet controlling a Television set at 8 PM so that by midnight all “idle” power is turned off and the power consumption of the TV is zero.

### BRIEF DESCRIPTION OF THE DRAWINGS

FIG. 1 illustrates a power module for incorporating into a variety of housings.

FIG. 2A shows the power module of FIG. 1 snapped into in a housing and showing the rear panel of the power module with three timer-controlled outlets.

FIG. 2B shows an alternative configuration of the power module of FIG. 1, slid into a housing and showing the rear panel of the power module with three timer-controlled outlets.

FIG. 3 shows the front panel of the power module as installed in a housing.

FIG. 4 shows a logic flow diagram of the control over timers and their associated relay controlled outlets.

FIG. 5 shows a schematic diagram of the circuit showing on-interval selection, pulse switch activation, integrated circuit timer and relay activation of two independent time intervals and the corresponding AC outputs.

FIG. 6 shows a representative housing incorporation the power module and storage bins for charged devices and separate bins for utility storage.

### DETAILED DESCRIPTION

Exemplary embodiments of the invention are described in detail below with reference to the appended figures, wherein like elements are reference with like numerals throughout. The figures are not necessarily drawn to scale and do not necessarily show every detail or structure of the various embodiments of the invention, but rather illustrate exemplary embodiments and mechanical features in order to provide and enabling description of such embodiments.

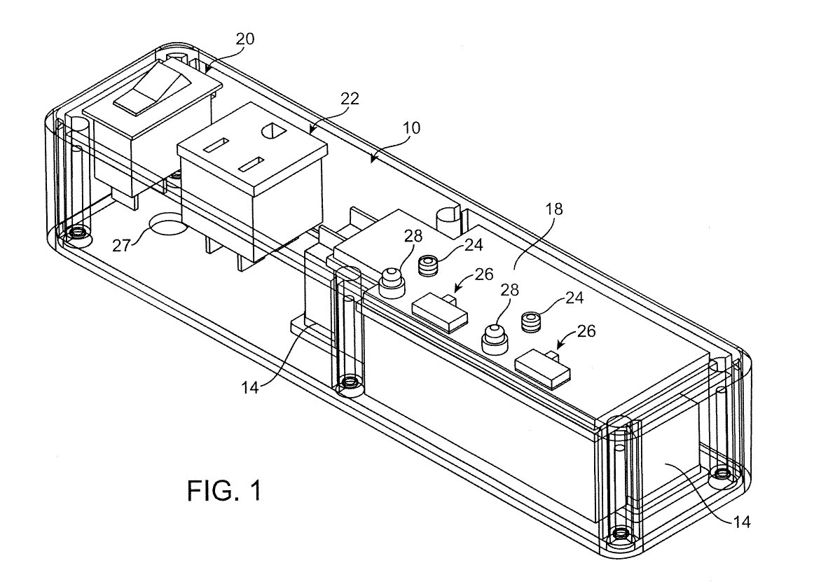

Referring to FIG. 1, a power module 10 with front panel 18 is illustrated. The front panel incorporates a master switch 20 which controls the timer controlled outlets 14 (two of which are partially visible on the rear panel).

Two three-position timer interval switches 26 are incorporated. These switches control the three outlets 14, with two outlets 14 having the same selected interval and the third timer controlled outlet have an independent timer interval. A plurality of outlets, such as a power strip, may be connected to one or more of the outlets 14. This enables multiple devices to be controlled by the same timer interval.

Pulse switches 28 initiate a timer on interval when pressed and released. When a timer interval is activated and while the timer is commanding an “on” condition, the associated LED indicator 24 is illuminated.

Outlet 22 is a utility outlet that is always on when the module is plugged into a active household AC outlet through a power cord (not shown) that exits the module through bore 27.

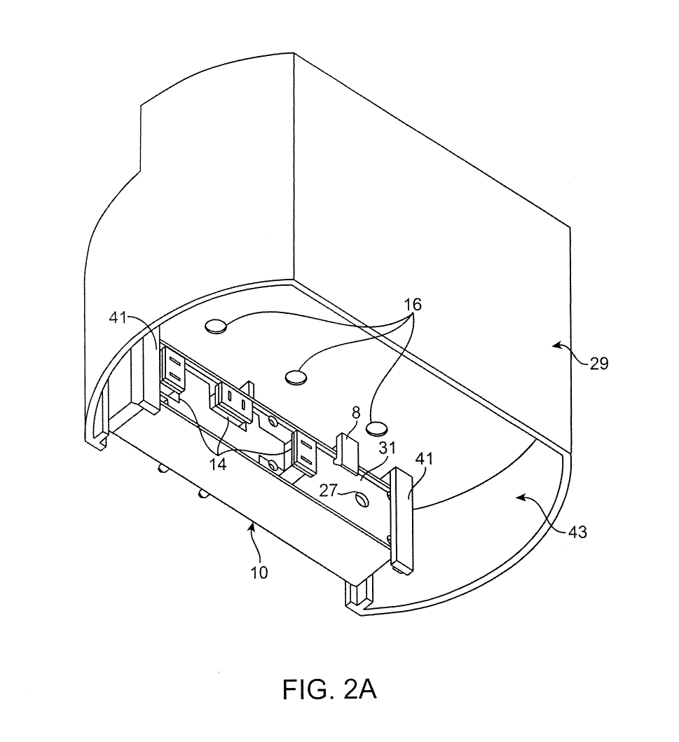

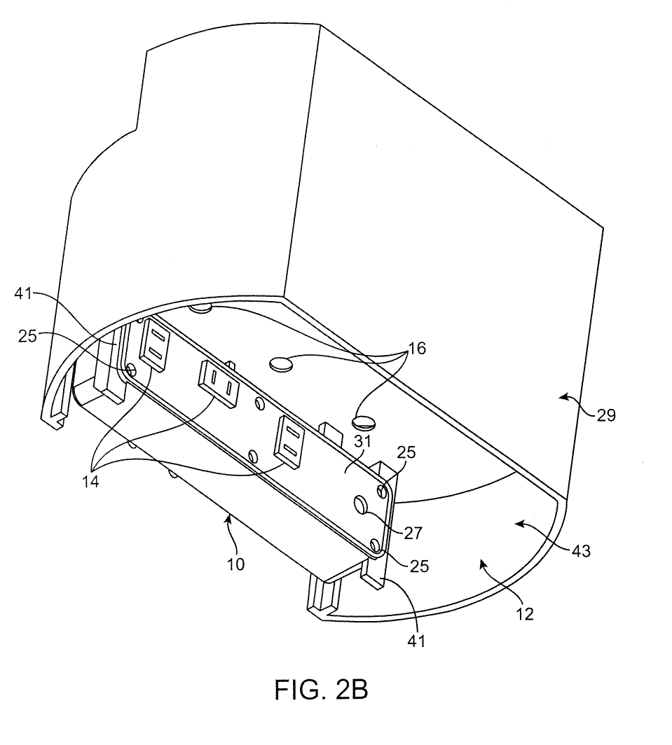

FIGS. 2A and 2B show a housing 29 with a lower volume 12 to accommodate a power module 10 and one or more charger adapters (not shown). In FIG. 2A, the module is snapped into place and held in position by tab 8 and rails 41. In FIG. 2B, a slightly modified module 10 with an extended rear panel face 31 is slid into position and secured through holes 25 to the rails 41 of housing 29. It will be noted that there is a stowage area 43 adjacent the outlets 14 to accommodate the bulky charger adapters typically associated with chargers for portable devices. When a user has inserted all desired power adapters in the associated outlets 14 and stowed the excess low voltage cords in the stowage area 43 the housing can be placed on a flat surface and thereby hide all of the bulk and excess cords of the power adapters from view. Alternatively a bottom plate (not shown) can be secured to the underside of the housing to fully enclose the charger adapters and excess cords.

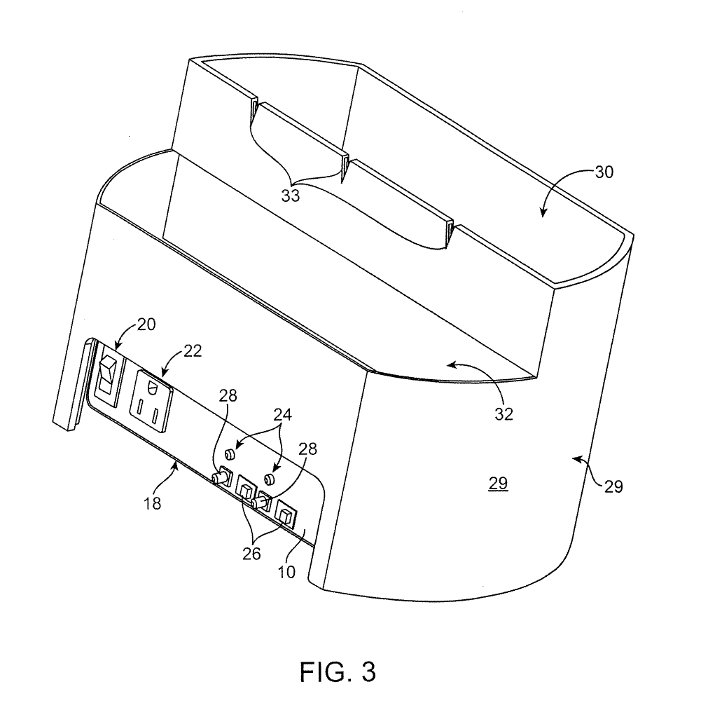

The ends of the charger adapter cords are fed through the holes 16 so that they can be plugged into the portable devices as will be more apparent from FIG. 3.

FIG. 3 is a front view of a housing 29 with the front face 18 of a power module 10 accessible at the lower portion of the housing. The master switch 20, utility outlet 22, the pulse switches 28, LED indicators 24, and slide switches 26 are all accessible to the user.

A portable device storage area 32 is provided at the front-top of the housing 29. Multiple portable devices can be stored here and charged from adapter cords fed up through the openings 16 (see FIG. 2).

Where necessary to prevent the adapter cords from feeding back down into the stowage area (under the influence of gravity) the cords can be doubled over and retained in the V-shaped slots 33. In this way only the minimum length of cord necessary to connect to the portable device is loose.

Housing 29 is shown to have a second storage area 30. This area is exemplary of the flexibility of the design accommodated by using a modular approach for the power module. In the illustrated housing the storage area may be utilized for utility storage of devices that would otherwise clutter the support surface. This can include, for example, pens, loose change and keys.

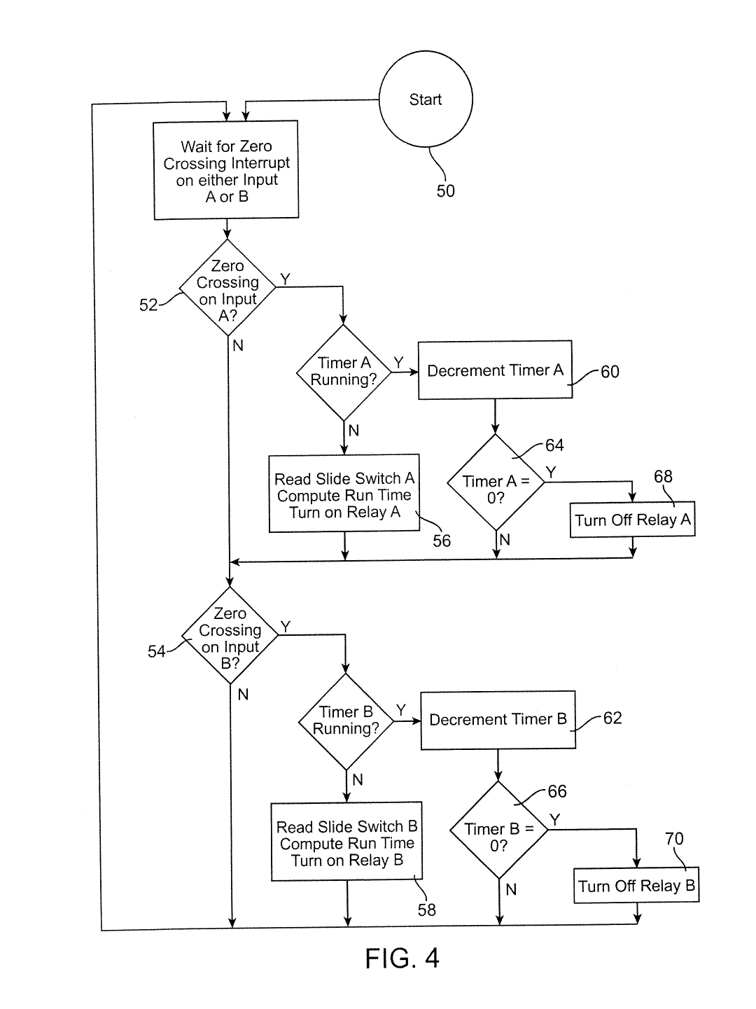

FIG. 4 is a flow diagram of the timer control circuitry. The diagram shows the control by timers A and B. These timers correspond to the timers controlled by the slide switches 26. The system is started at 50, by powering up the master switch 20 (all references to features numbered less than 50 are by reference to FIG. 1). Once started the system waits for a pulse of one of the switches 28 which is detected by zero crossing detectors at 52 and 54. The net effect of initiating a timer is to turn on a relay at 56 or 58 for an interval selected by slide switches 26. The remaining time on the timer is decremented at 60 and 62 and tested for zero time remaining at 64 and 66. When the timers time out, the associated relays are switched off at 68 and 70.

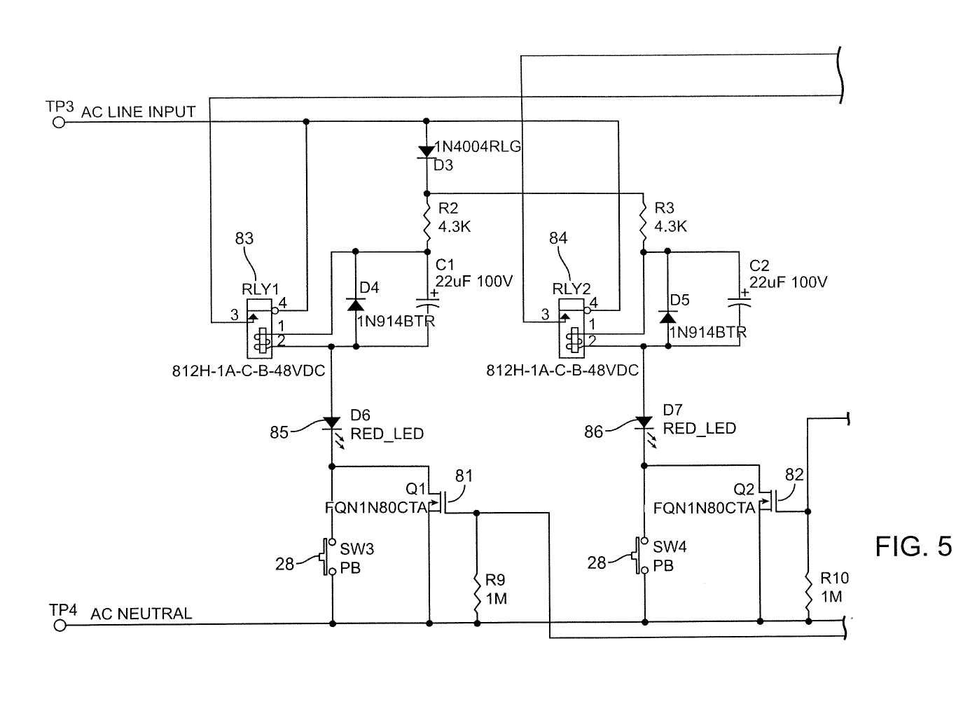

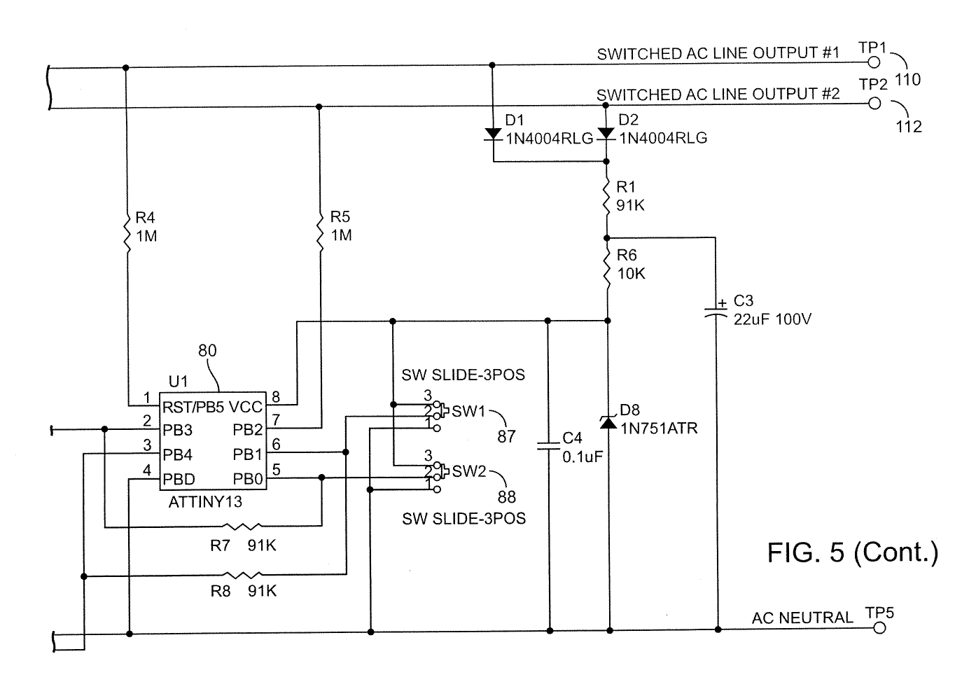

FIG. 5 is a schematic diagram of the circuitry controlling the timed outlets. The exemplary embodiment employs a timer 80 from ATMEL series ATTINY13. The timer 80 receives power when a pulse switch 28 turns on Q1 (81) or Q2 (82) which closes the selected relay RLY1 (83) or RLY2 (84) which also turns on the appropriate LED D6 (85) or D7 (86). Timer 80 detects the selected time interval by reading the slide switches SW1 (87) or SW2 (88). When the timer counts down to zero, the output at pins PB3 or PB4 of the timer 80 goes to zero and shuts of the associated relay which turns off the power on output 1 (110) or output 2 (112).

The relays may be either latching or non-latching relays. To conserve energy, latching relays are preferred because they only consume power while being switched. It is to be understood, however, that non-latching relays may also be used. In order to conserve energy when non-latching relays are used, a pulse width modulation (PWM) algorithm may be employed. Doing so decreases the effective duty cycle of the relays, thus decreasing power consumption, while still ensuring that the relays remain in the desired state.

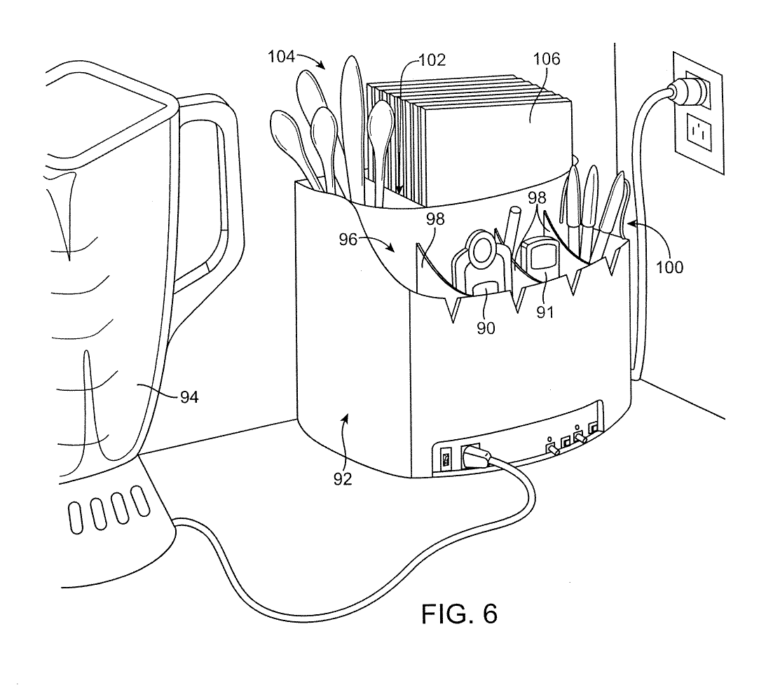

Referring to FIG. 6, there is illustrated a device according to the invention which is in use to control charging power to exemplary portable devices. These devices are carried in another variation of the housing, housing 92. In this variation the front storage area is segmented by dividers 98. The segmentation allows for the storage of miscellaneous items in the front compartment, such as pens 100. The rear storage compartment 102 is showing carrying utensils 104 and napkins 106. The utility outlet is in use to power a blender 94.

While specific embodiments and components have been described because of their utility with the invention and for completeness of the disclosure, many variations will occur to persons who become familiar with the art. Therefore, the scope of the invention should be assessed solely by reference to the appended claims.

Various modifications and alterations of the invention will become apparent to those skilled in the art without departing from the spirit and scope of the invention, which is defined by the accompanying claims.

Any element in a claim that does not explicitly state “means for” performing a specified function or “step for” performing a specified function is not to be interpreted as a “means” or “step” clause as specified in 35 U.S.C. §112, ¶ 6.

What is claimed is:

1. An AC powered charging station for multiple charger adapters comprising:
a housing having at least one stowage volume, said at least one stowage volume having at least three sides collectively sized to accommodate multiple charger adapters;
a plurality of AC outlets, wherein at least one of the plurality of AC outlets is accessible from said stowage volume,
at least one relay connected to at least one relay controlled AC outlet accessible from said stowage volume,
at least one timer connected to at least one relay controlled AC outlet, and a timer activation switch for initiating a power on cycle of at least one timer.

2. The AC powered charging station of claim 1, further including:
a storage area for portable devices, and
a plurality of leads for leading DC cords from the stowage volume to said storage area.

3. The AC powered charging station of claim 2 wherein said storage area is positioned on top of said stowage area and comprises a base and an open-topped recess with retainer walls on at least three sides.

4. The AC powered charging station of claim 2 wherein said leads comprise openings in said stowage volume connecting to said storage area and sized to accept the DC power plugs on the charger adapters.

5. The AC powered charging station of claim 4, further comprising cord retention elements to releasably holds the DC cords in position in said storage area.

6. The AC powered charging station of claim 1 further comprising a timer interval selection switch for selecting between multiple on-times of said relay.

7. The AC powered charging station of claim 1, wherein said stowage area is closed at the bottom by a removable floor.

8. The AC powered charging station of claim 7, wherein said floor is comprised of mesh to allow ventilation of said stowage volume, said mesh being removably secured by fasteners to a plurality of sides of said stowage volume.

9. The AC powered charging station of claim 1, wherein said at least one relay is a latching relay.

10. The AC Powered charging station of claim 1, further comprising a plurality of outlets connected to at least one of said relay controlled AC outlets.

11. The AC powered charging station of claim 10, wherein the plurality of outlets connected to at least one of said relay controlled AC outlets is a power strip.
